(19) United States
(12) Patent Application Publication
(10) Pub. No.: US 2026/0013439 A1
(43) Pub. Date: Jan. 15, 2026

(54) IMPROVED RAKE WHEEL ASSEMBLIES AND METHODS OF MAKING THE SAME

(71) Applicant: MYERS SPIRING, INC., Logansport, IN (US)

(72) Inventors: Arthur Todd Miller, Logansport, IN (US); John Brown, Logansport, IN (US); Roger Byrum, Logansport, IN (US)

(21) Appl. No.: 18/993,605

(22) PCT Filed: Jul. 20, 2023
(86) PCT No.: PCT/US23/70617

§ 371 Date: Jan. 13, 2025

Related U.S. Application Data
(60) Provisional application No. 63/391,353, filed on Jul. 22, 2022.

(51) Int. Cl. A01D 80/02; A01D 78/10

(52) U.S. Cl. CPC A01D 80/02; A01D 78/1064

(57) ABSTRACT

An improved rake wheel assembly is provided, the rake wheel having a plurality of spring tooth tines which pass through individual mounting holes in an outer hoop, each mounting hole includes a support member which supports a portion of the length of the spring tooth tine to better dissipate forces applied to the body of the spring tooth tine and increase tine durability and longevity.

### PRIORITY

The present application is related to and claims priority to U.S. Provisional Patent Application No. 63/391,353 filed on Jun. 22, 2022, titled “Improved Hay Rake Wheel Assemblies” which is incorporated herein by reference.

### TECHNICAL FIELD

The present disclosure relates generally to devices for use in the processing and harvesting of fodder crops and, more particularly, to devices for raking hay and other fodder crops.

### BACKGROUND

The production of fodder crops such as hay or other grasses as well as the straw byproduct of cereal crops (wheat, oats, barley, and the like), and the byproducts of other crops such as soybean stalks, corn stalks, or other loose plant material involves multiple steps. Typically such crops are mowed or cut, dried in the field, then collected either as loose material using a forage harvester or processed into bales using a baler. Prior to the collection process, and often as part of the drying process, the loose material is gathered and rolled into windrows using a mechanical implement such as a rake or hay rake. A common style of rake typically referred to as a wheel or star wheel style rake includes two or more spring toothed wheels 10 mounted on a frame which rotate when pulled behind a tractor so as to gather, roll, and pile into rows a forage crop.

As seen in FIGS. 1-3, the rake wheel 10 includes an inner disk or hub 12 as well as an outer hoop or rim 16. The hub 12 has a mounting point 14 which allows the wheel 10 to be rotatably mounted to an axel on the rake. The hoop 16 includes a plurality of mounting holes 20 spaced about its circumference. A plurality of spring tooth or fingers 18 are mounted at one end to the hub 12 and pass through the mounting holes 20 of the hoop 16 and extend beyond the edge of the hoop 16 to give the appearance of a “star”. The spring tooth 18 outside the diameter of the hoop 16 typically has a first bend 24 and a second bend 26 such that the spring tooth has a generally fish hook shape. When in use, the wheel rotates 22 (either from free wheeling caused by contact with the ground or by power supplied by a tractor's PTO system). The rotating wheel 10 collects and rolls loose fodder into a continuous windrow which may then be collected and harvested or allowed to further dry as desired.

Each spring tooth 18 has a distal end 30 and a proximal end 34 as seen in FIG. 2 (several spring teeth removed for clarity). The proximal end is mounted to the hub 12 using a suitable attachment method such as clips, clamps, bolts, welds, and the like. During normal operation rotation of the wheel 10 is generated by a portion of the spring tooth 18 contacting the ground. This contact typically occurs at or near the second bend 26 and also generates a force 32 along a portion of the length of the spring tooth 18. Over time, this force 32 repeatedly flexes the body of the spring tooth 18 causing wear at the point where the spring tooth meets the outer hoop 16 reducing the cross section of the material of the spring tooth thus accelerating the fatigue both in bending and torsion and eventually breakage of the spring tooth 18 in a failure region 28 at or near the first bend 24. Once one spring tooth is broken the wear and eventually breakage of additional spring teeth increases. Replacing individual spring teeth as they break can in some instances result in misalignment of the hoop (16) relative to the spring teeth (18) which can cause binding between them leading to increased fatigue and thus accelerated breakage of older teeth. Continuing to operate a wheel with one or more broken teeth can lead to decreased performance and missed collection of fodder material which passes through gaps created by missing or broken teeth. Eventually the entire wheel must be replaced which is both expensive and time consuming. The simple and effective design of wheel style rakes has ample room for improvement to increase the longevity of the spring teeth and thereby the rake wheel itself.

### SUMMARY OF THE INVENTION

In one aspect, an improved rake wheel having a hub with a mounting portion mountable to a rotating axel, a hoop disposed about the hub, the hoop being made from a bar stock having a particular thickness and having a plurality of mounting holes formed therein where each mounting hole has a support body associated with it which extends at a distance from the inner surface of the hoop towards the hub. A plurality of spring toothed tines which have a proximal end attached to the hub, a medial body portion which passes through a mounting hole, and a distal end which is disposed outside the diameter of the hoop. A portion of each spring tooth tine abuts against the support body associated with the mounting hole the tine passes through. The support bodies may be formed from material displaced inward when a mounting hole was formed in the hoop. The support bodies may extend inward towards the hub for a distance that is at least twice the thickness of the material from which the hoop is formed.

In another aspect, a rake wheel for a hay rake having a hub mountable to a axel and a plurality of tine attachment points is disposed within a hoop having a plurality of mounting holes formed therethrough, each mounting hole having associated with it a support body which extends inward towards the hub from the hoop. A plurality of tines each tine having a proximal end mounted to the hub at an attachment point, a distal end which is disposed outside the diameter of the hoop, and a medial portion which passes through one of the plurality of mounting holes such that part of the medial portion abuts the support body associated with that mounting hole. The support bodies may be formed from material displaced inward when a mounting hole was formed in the hoop.

In yet another aspect a rake wheel assembly having s hub assembly with a plurality of tine attachment points, a hoop disposed about the hub having a plurality of tine mounting passages therethrough, each mounting passage being associated with a support body extending inward towards the hub, and a plurality of tines each having a proximal end mounting to a tine attachment point on the hub, a medial portion extending through a tine mounting passage so as to abut a support body, and a distal end disposed outside of the diameter of the hoop. The support bodies may be formed from material displaced inward when a mounting passage was formed in the hoop. The support bodies may extend inward towards the hub for a distance that is at least twice the thickness of the material from which the hoop is formed. The support bodies may also be made from bushings or other material added to the hoop after the mountain passage was formed in the hoop.

### BRIEF DESCRIPTION OF THE DRAWINGS

FIG. 1 is a front plan view of a rake wheel according to the prior art:

FIG. 2 is a front plan view of a portion of the rake wheel of FIG. 1:

FIG. 3 is a perspective view of a portion of the rake wheel of FIG. 1:

FIG. 4 is a front plan view of a rake wheel according to one embodiment:

FIG. 5 is a front plan view of a portion of the rake wheel of FIG. 4;

FIG. 6 is a perspective view of a portion of the rake wheel of FIG. 4:

FIG. 7 is a perspective view of a portion of FIG. 6.

FIG. 8 is a perspective view of a rake wheel according to another embodiment.

FIG. 9 is a perspective view of a portion of the rake wheel shown in FIG. 8.

FIG. 10 is a perspective view of a bushing shown in FIG. 8.

FIG. 11 is a perspective view of a rake wheel according to yet another embodiment.

FIG. 12 is a perspective view of a portion of a rake wheel hoop according to one embodiment.

### DETAILED DESCRIPTION

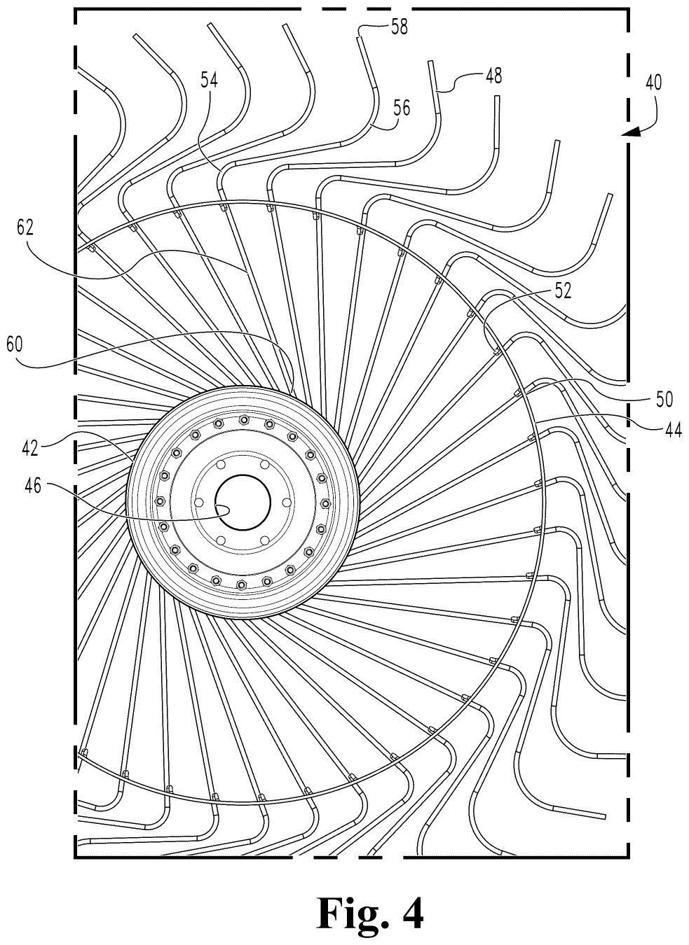

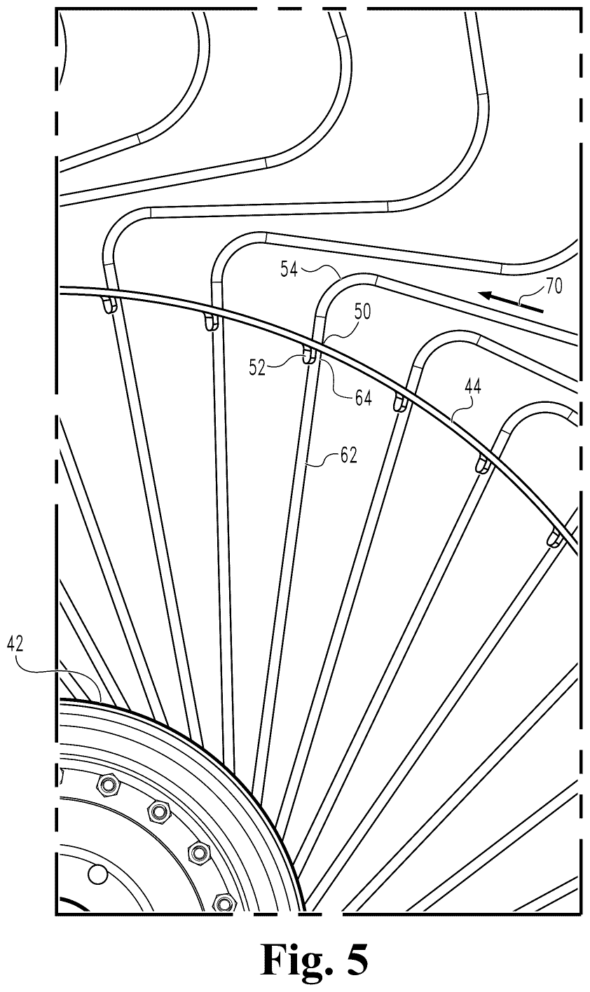

Referring now to FIGS. 4-7, a front plan view of an improved hay rake or rake wheel assembly 40 is shown according to one embodiment is shown. Such rakes are commonly used to gather loose plant material into rows for later collection and/or processing, for example, fodder material (hay, grasses, and the like), straw or bedding material (stalks from wheat, oats, and other cereal crops), and plant stalks or other plant material (soybeans, corn stalks, and the like). In this particular embodiment, the rake wheel 40 includes an inner hub portion 42 as well as an outer hoop portion 44. The hub 42 has a mounting portion 46 which allows the wheel 40 to be rotatably mounted to an axel on a rake. The hoop 44 includes a plurality of mounting holes or passages 50 spaced about its circumference which will be discussed in greater detail below: The wheel 40 also includes a plurality of spring tooth or fingers 48 which have a distal end 58, a proximal end 60, and a medial portion 62 disposed therebetween. Each spring tooth 48 is mounted at the proximal end to the hub 42 using a suitable attachment method such as clips, clamps, bolts, welds, and the like. The body of a spring tooth 48 extends from the hub 42 to the hoop 44 and passes through a mounting hole 50. Each spring tooth 48 further includes a first bend portion 54 and a second bend portion 56 located outside the diameter of the hoop 44.

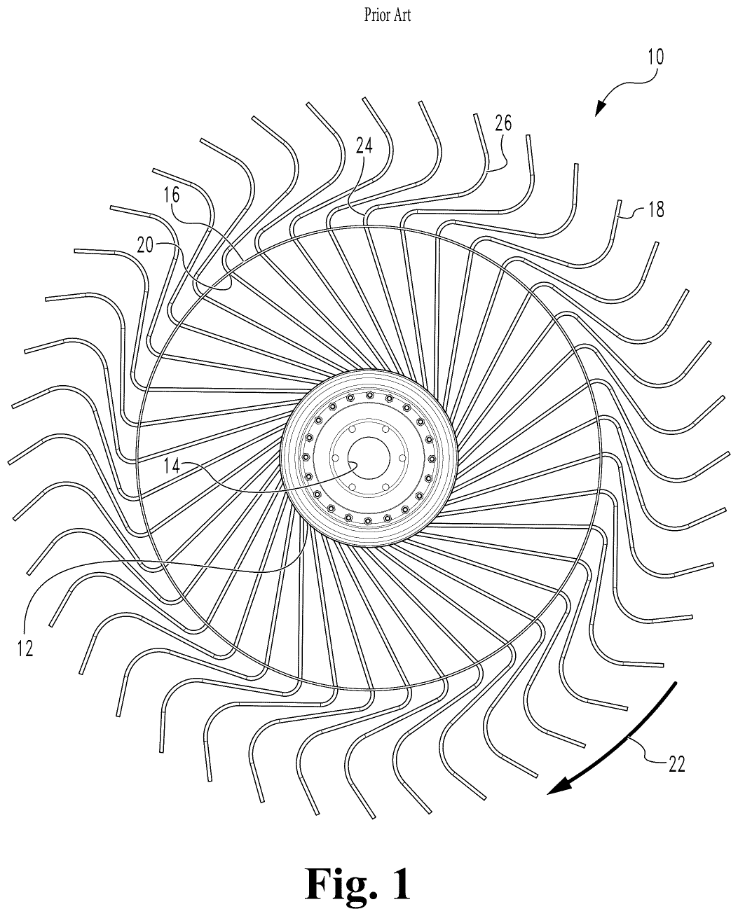

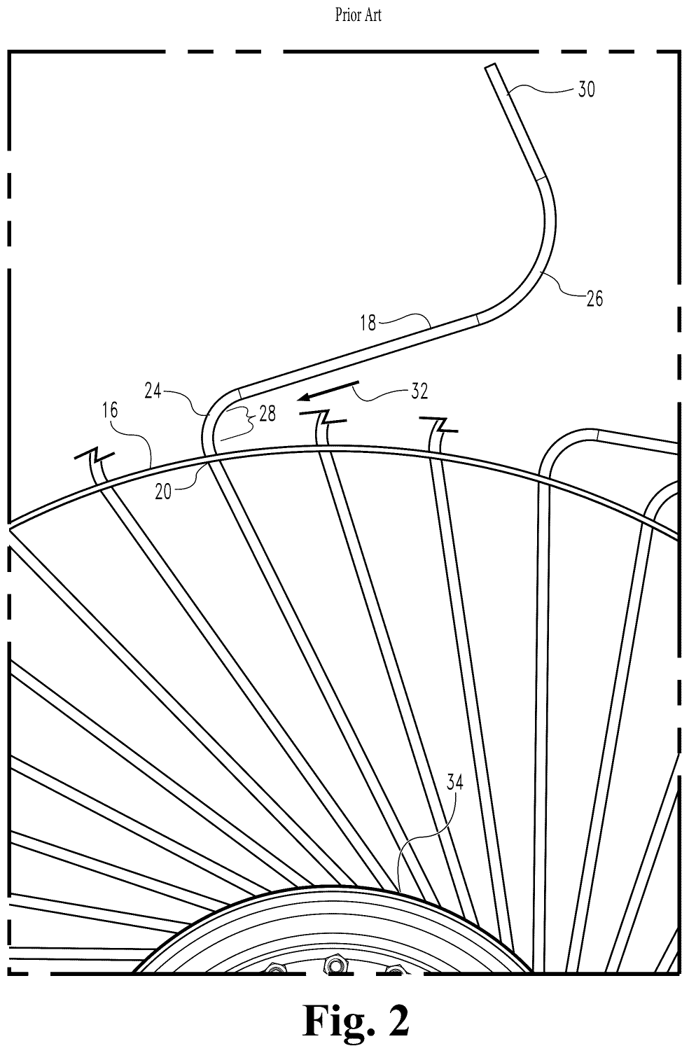

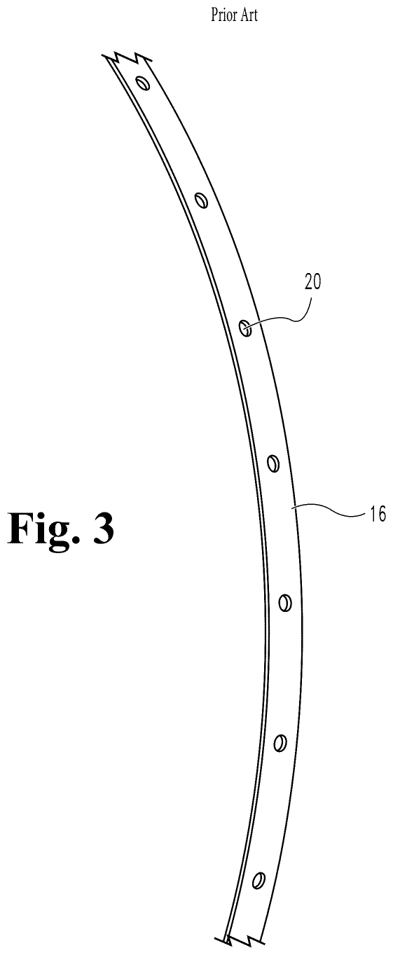

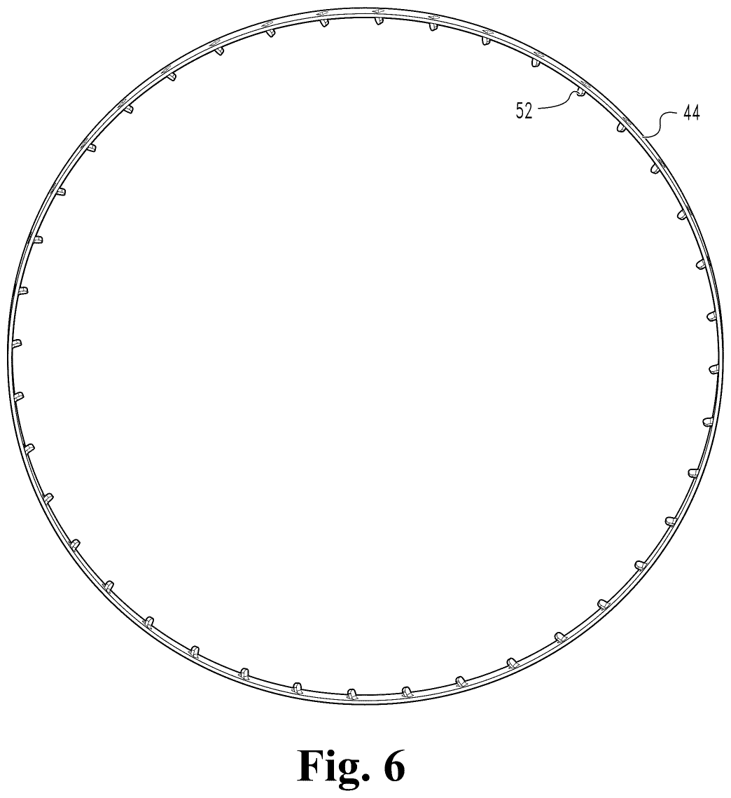

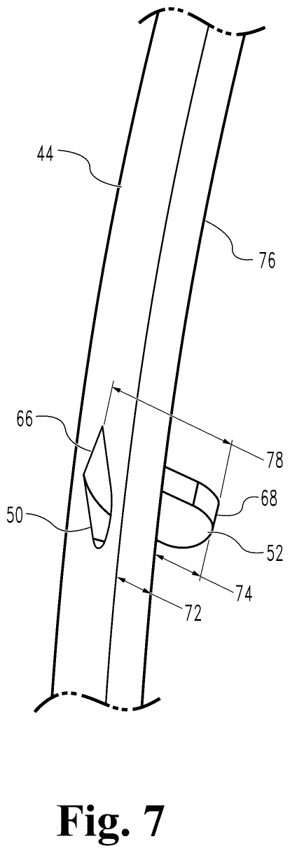

FIGS. 6-7 show the hoop 44 in greater detail. The hoop 44 includes a plurality of mounting holes or passages 50 through which the spring teeth pass. In the rake wheel shown in FIGS. 1-3 the mounting holes 20 are round and are typically formed by punching, drilling, or otherwise machining a series of holes spaced at regular intervals along the length of a flat piece of bar stock material. Once the mounting holes 20 have been formed the flat bar stock is then formed into a hoop 16. In one embodiment, the hoop 44 used in the improved rake wheel 40 is created by first forming a piece of flat bar stock into a hoop shape and then forming a plurality of mounting holes 50 therein. Each mounting hole 50 is cut or formed such that material from the newly formed hole creates a tab or support body 52. As shown in FIG. 7 the support body 52 is generally shaped as a rectangular solid having one curved end. In other embodiments the tab or support body may have different shapes such as generally disk/circular shape, generally square or rectangular body, or other shapes as desired. Each support body 52 has a free portion 68 which has been cut free from the body of the hoop 44 and an attached portion 66 which remains attached to the hoop 44 after the mounting hole 50 has been formed. The mounting holes may be formed using any suitable means such as thermal lancing, punching, and the like. The bar stock material used to form the hoop 44 has a thickness 72. Typically, the stock material has a width of 1 inch and a nominal thickness of 0.1875 inches, but the teachings herein may be used with hoops made from thicker or thinner starting material. The support body 52 may be cut as so as to have a desired overall length 78 and have a length 74 which extends inward from the inner hoop surface 76. The support body length extension 74 may be longer or shorter as desired, but typically the support body length 74 extending inward from the inner hoop surface 76 is at least twice the thickness 72 of the hoop material, more typically the support body length 74 is at least four times the thickness 72 of the hoop material. In other embodiments, the support body length 74 extending inward from the inner hoop surface 76 is longer or shorter as desired. Optionally, additional material may be added to increase the length of the support body (such as by welding, brazing, and the like).

A portion of the medial portion 62 of each spring tooth tine 48 contacts the support body 52 when passing thought within the mounting hole 50. This supported portion 64 of the spring tooth 48 which contacts the support body 52 allows an applied force 70 caused by the rake wheel contacting the ground to be spread over a greater length of spring tooth 48. By spreading the force over a greater length of the spring tooth each spring tooth wears slower and lasts longer than the traditional style of rake wheel such as that shown in FIGS. 1-3. Additionally, the support body 52 provides a more generally curved/tapered surface which contacts the tine 48 when compared to the sharp edge of the through holes used in traditional rake wheels such as that shown in FIGS. 1-3. The increased durability of this particular embodiment is achieved without having to increase the diameter of the spring tooth tines and without having to add additional material to the outer hoop.

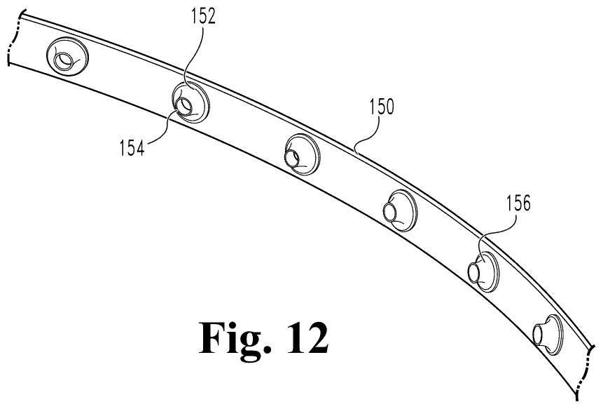

Alternatively, a hoop for an improved rake wheel may be formed with mounting holes and associated support structures. One such example is shown in FIG. 12 which shows a portion of a hoop 150 having a plurality of mounting holes 154 formed therein. Each mourning hole 154 is formed with an associated support structure 152 which has a generally frustoconical shape. The tapered neck portion 156 of the support structure 152 is sized and configured so as to support a spring tooth tine body passing therethrough.

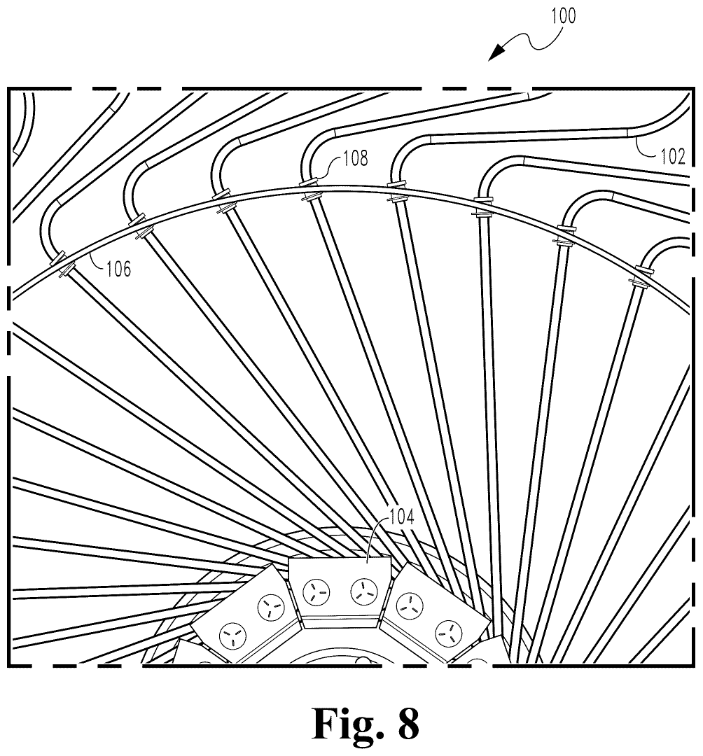

In other embodiments, the support body or tab may be welded or otherwise fused to a hoop at a suitable location relative to a mounting hole. In still other embodiments a bushing or ferrule may be mounted to each mounting hole such that a spring tooth tine passes therethrough. In such embodiments the bushing or ferrule would support the entire circumference of a portion of the spring tooth rather than just one side and might be formed from metal, plastic, or other suitable material. One Examples of such embodiments using bushings are shown in FIGS. 8-11, but bushings or ferrules of other shapes, sizes, and configurations may also be used.

The rake wheel embodiments shown in FIGS. 4-7 and 12 utilize support structures formed from and/or added to the hoop body to provide additional support to the spring tooth tines. Alternatively, separate bodies such as bushings, ferrules, and the like may be inserted through openings in a hoop to provide additional support for the spring tooth tines. Such separate bodies may be sized and shaped as desired and may be made from any suitable material such as metal, plastic, and the like. One such alternative embodiment of an improved rake wheel 100 is shown in FIGS. 8-10. In this particular embodiment, the rake wheel 100 includes an inner hub portion 104 as well as an outer hoop portion 106. The hoop 106 includes a plurality of mounting holes 114 spaced about its circumference which will be discussed in greater detail below. The wheel 100 also includes a plurality of spring tooth or fingers 102. Each spring tooth 102 is mounted at the proximal end to the hub 104 using a suitable attachment method such as clips, clamps, bolts, welds, and the like. The body of a spring tooth 102 extends from the hub 104 to the hoop 106 and passes through a bushing 108 disposed in a mounting hole 114 on the hoop 106.

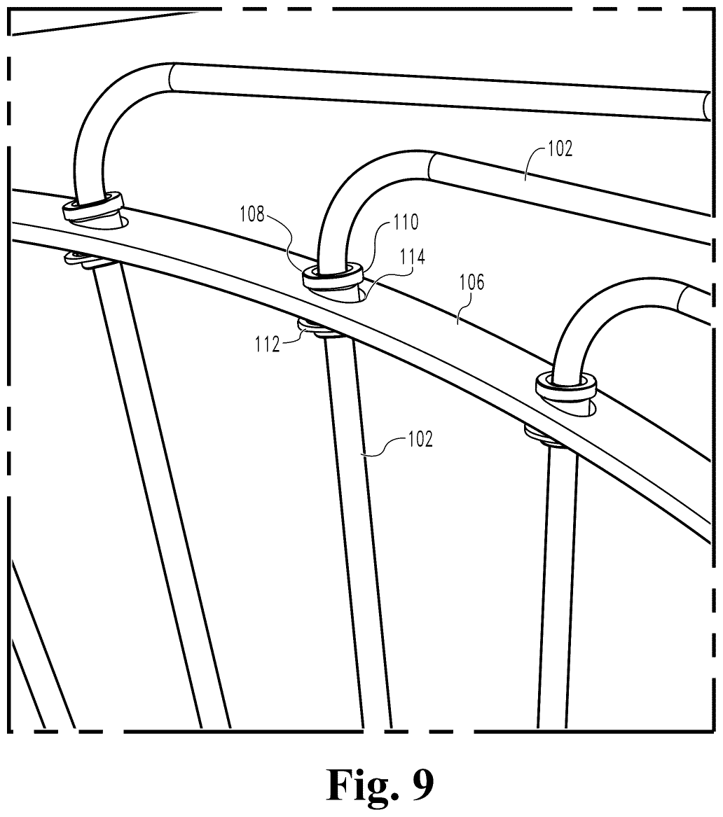

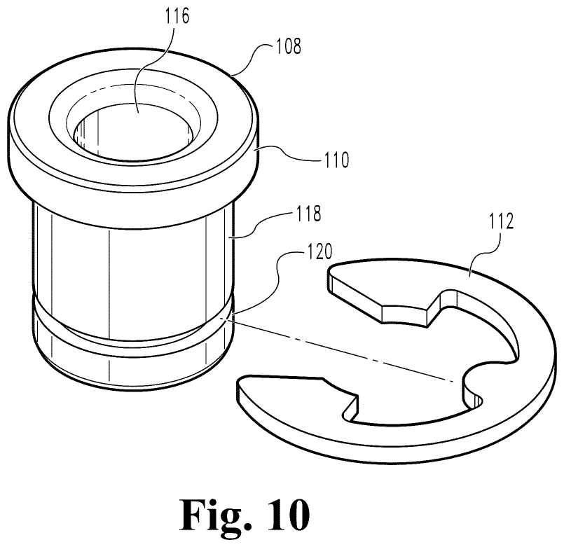

As seen in FIGS. 9-10, each bushing 108 includes a larger head portion 110 and a narrower body portion 118. The body portion 118 is sized so that it will pass through a mounting hole 114 in the hoop 106 and the head portion 110 is sized so that it will not pass through a mounting hole 114. Once inserted through a mounting hole 114, a c-clip/retaining clip 112 is mounted to an associated mounting groove 120 on the bushing 108 to prevent the bushing 108 from sliding out of the mounting hole 114. In other embodiments, retaining methods other than c-clips may also be used such as welding, soldering, brazing, threads, press fitting, and the like may be used to insure the bushings remain in the mounting holes. Each bushing 108 further includes a bore 116 passing therethrough sized such that the diameter of a tine 102 may pass therethrough. The bore hole 116 edge may be smoothed so as to prevent the bushing from excessively rubbing or cutting into the body of the tine 102. The bushings 108 perform a similar function to the support bodies 52 discussed with respect to the embodiment shown and described in FIGS. 4-7. That is, the body portion 118 of the bushing 108 provides support to the spring tooth tine 102 passing therethrough and acts to counter forces applied to the tine 102 during normal use thereby lengthening the lifespan of the tine 102.

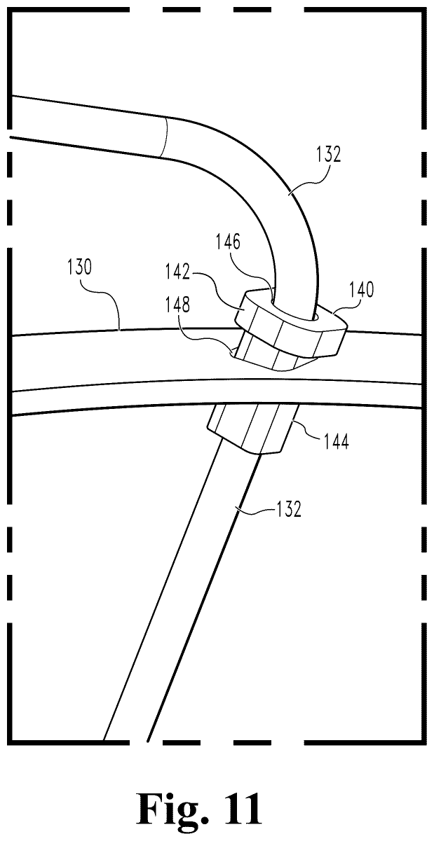

FIG. 11 shows a portion of an improved rake wheel according to yet another embedment. In this particular embodiment, the improved rake wheel includes a hoop 130 having a plurality of mounting holes 148 formed therein. A bushing 140 having a head portion 142 and a narrower body portion 144. The bushing 140 includes a passage 146 therethrough sized such that a spring tooth tine 132 may pass therethrough. The body portion 144 is sized so that it will pass through a mounting hole 148 in the hoop 130 and the head portion 142 is sized so that it will not pass through a mounting hole 148. Optionally the bushing 140 may be secured to the hoop 130 by any suitable means such as by clips similar to those shown in FIGS. 8-10 or by welding, soldering, brazing, threads, press fitting, and the like. The body portion 144 of the bushing 140 provides support to the spring tooth tine 132 passing therethrough and acts to counter forces applied to the tine 132 during normal use thereby lengthening the lifespan of the tine 132.

Standard rake wheels are typically 35 to 60 inches in diameter, but the teachings herein may be applied to rake wheels of larger or smaller diameters. Spring tooth tines on wheel rakes are typically 7 mm in diameter, but tines of larger or smaller diameters may also be used and commonly is determined by factors such as cost of materials, weight of the final product, desired spring rate in the final tine, and the like. Rake wheels incorporating the teachings contained herein may be used as replacements for existing rake wheels as they age and fail on existing rakes in addition to being standard equipment on new rakes. Rake wheels disclosed herein may also include additional features such as plating or covers over the portion of the spring tooth tines located between the wheel hub and the outer hoop. Such plating or covering are designed to prevent loose hay or other fodder from becoming lodged between the tines and inhibiting rotation of the wheels. The use of other such modifications or attachments with wheels which incorporate the teachings herein are also contemplated.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. As noted above, the teachings set forth herein are applicable to a variety of different assemblies, devices, systems, and methods like having or employing a variety of different structures than those specifically described herein. Other aspects, features, and advantages will be apparent upon an examination of the attached drawings and appended claims. As used herein, the articles “a” and “an” are intended to include one or more items, and may be used interchangeably with “at least one.” Where only one item is intended, the term “one” or similar language is used. Also, as used herein, the terms “has,” “have,” “having,” or the like are intended to be open-ended terms.

1. An improved rake wheel, comprising:
a hub having a mounting portion, the mounting portion being mountable to an axle;
a hoop disposed about the hub, the hoop having a plurality of mounting holes formed therein, each mounting hole having a support body associated therewith which extends at a distance inward from the hoop towards the hub; and
a plurality of spring tooth tines, the tines having a proximal end, a distal end, and a medial portion disposed therebetween, the proximal end of each of the plurality of tines being mounted to the hub, each of the plurality of tines extending through a mounting hole on the hoop such that the distal end of the tine is outside of the diameter of the hoop and that a part of the medial portion of the tine abuts the support body associated with that mounting hole.

2. The rake wheel of claim 1, wherein the hoop is made from a material having a specific thickness and each of the support bodies extends inward from the hoop towards the hub at a distance that is at least twice the thickness of said hoop material.

3. The rake wheel of claim 1, wherein the hoop is made from a material having a specific thickness and each of the support bodies has an overall length of at least four times the thickness of the hoop material.

4. The rake wheel of claim 1, wherein the support body associated with each of the plurality of mounting holes is made from material displaced from the hoop to form said mounting hole.

5. The rake wheel of claim 4, wherein each of the plurality of mounting holes is formed by thermal lancing so as to displace hoop material inward to form said mounting hole.

6. The rake wheel of claim 4, wherein the support body has a frustoconical shape.

7. The rake wheel of claim 1, wherein each of the plurality of support bodies is a bushing mounted through each mounting hole.

8. A rake wheel for a hay rake, comprising:
a hub having an axel mounting portion and a plurality of tine attachment points;
a hoop disposed about the hub, the hoop having a plurality of mounting holes formed therethrough and a support body associated with each mounting hole extending inward from the hoop from said mounting hole; and
a plurality of tines, the tines each having a proximal end, a distal end, and a medial portion therebetween;
wherein the proximal end of each of the plurality of tines is attached to the hub at a tine attachment point;
wherein the medial portion of each of the plurality of tines passes through one of the plurality of mounting holes in the hoop such that the tine abuts the support body associated with that mounting hole;
wherein the distal end of each of the plurality of tines is disposed outside the diameter of the hoop.

9. The hay rake wheel of claim 8, wherein the support body associated with each of the plurality of mounting holes is made from material displaced from the hoop to form said mounting hole.

10. The hay rake wheel of claim 9, wherein he support body associated with each of the plurality of mounting holes is frustoconical shaped.

11. The hay rake wheel of claim 9, wherein each of the plurality of mounting holes is formed by thermal lancing so as to displace hoop material inward to form said mounting hole.

12. The hay rake wheel of claim 8, wherein each of the support bodies comprises material added to said hoop.

13. The hay rake wheel of claim 12, wherein the added material is a bushing.

14. A rake wheel assembly, comprising:
a hub having a plurality of tine attachment points;
a hoop disposed about the hub, the hoop having a plurality of tine mounting passages therethrough and a support body associated with each mounting passage extending inward towards the hub; and
a plurality of tines, the tines each having a proximal end, a distal end, and a medial portion disposed therebetween, the proximal end being mounted to a tine attachment point on the hub, the medial portion extending through a tine mounting passage so as to abut a support body, the distal end being disposed outside the diameter of the hoop.

15. The rake wheel assembly of claim 14, wherein the hoop is made from a material having a specific thickness and each of the support bodies extends inward from the hoop towards the hub at a distance that is at least twice the thickness of said hoop material.

16. The rake wheel assembly of claim 14, wherein the hoop is made from a material having a specific thickness and each of the support bodies has an overall length of at least four times the thickness of the hoop material.

17. The rake wheel assembly of claim 14, wherein the support body associated with each of the plurality of mounting passages is made from material displaced from the hoop to form said mounting passage.

18. The rake wheel assembly of claim 17, wherein each of the plurality of mounting passages is formed by thermal lancing so as to displace hoop material inward to form said mounting passage.

19. The rake wheel assembly of claim 17, wherein the support body has a frustoconical shape.

20. The rake wheel assembly of claim 14, wherein each of the plurality of support bodies is a bushing mounted through each mounting passage.
